(19) United States
(12) Patent Application Publication
(10) Pub. No.: US 2008/0192869 A1
(43) Pub. Date: Aug. 14, 2008

(54) Scalable Data Reception Gain Control for a Multiple-Input, Multiple-Output (MIMO) Communications System

(75) Inventors: Manish Goel, Plano, TX (US); David P. Magee, Plano, TX (US); Michael T. DiRenzo, Coppell, TX (US); Michael O. Polley, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/106,548

(22) Filed: Apr. 21, 2008

Related U.S. Application Data
(62) Division of application No. 10/953,544, filed on Sep. 29, 2004.
(60) Provisional application No. 60/540,628, filed on Jan. 29, 2004.
(60) Provisional application No. 60/540,654, filed on Jan. 29, 2004.

(51) Int. Cl. H04L 27/08

(52) U.S. Cl. 375/345

(57) ABSTRACT

The present invention provides a concurrent gain generator for use with a MIMO transmitter havi'ng an N of two or more transmit antennas. In one embodiment, the concurrent gain generator includes a first sequence formatter that provides one of the N transmit antennas with a gain training sequence during an initial time interval, and a second sequence formatter that further provides (N−1) remaining transmit antennas with (N−1) additional gain training sequences during the initial time interval to train receive gains. The present invention also provides a non-concurrent gain adjuster for use with a MIMO receiver employing an M of two or more receive antennas. In one embodiment, the non-concurrent gain adjuster includes a gain combiner that computes a common receive gain as a function of M independent receive gains, and a gain applier that applies the common receive gain to receivers associated with the M receive antennas.

### CROSS-REFERENCE TO RELATED APPLICATIONS

The present application is based on and claims priority of U.S. Provisional Patent Application Ser. No. 60/540,628, filed on Jan. 29, 2004, by Manish Goel, et al., entitled ASlot-Optimized Preamble Structure for Proper AGC Training in MIMO-OFDM Systems, @ commonly assigned with the present application and incorporated herein by reference. The present application is also related to U.S. Provisional Patent Application Ser. No. 60/540,654, filed on Jan. 29, 2004, by David P. Magee, et al., entitled AAGC Training for Wireless MIMO Communication Systems, @ commonly assigned with the present invention and incorporated herein by reference.

### TECHNICAL FIELD OF THE INVENTION

The present invention is directed, in general, to communication systems and, more specifically in one aspect, to a concurrent gain generator, a method of gain generating and a MIMO communications system employing the generator or the method of gain generating. The present invention is also specifically directed, in another aspect, to a non-concurrent gain adjuster, a method of gain adjusting and a MIMO communications system employing the adjuster or the method of gain adjusting.

### BACKGROUND OF THE INVENTION

Multiple-input, multiple-output (MIMO) communication systems differ from single-input, single-output (SISO) communication systems in that different data symbols are transmitted simultaneously using multiple antennas. MIMO systems typically employ a cooperating collection of single-dimension transmitters to send a vector symbol of information, which may represent one or more coded or uncoded SISO data symbols. A cooperating collection of single-dimension receivers, constituting a MIMO receiver, then receives one or more copies of this transmitted vector of symbol information. The performance of the entire communication system hinges on the ability of the MIMO receiver to establish reliable estimates of the symbol vector that was transmitted. This includes establishing several parameters, which includes receiver automatic gain control (AGC) for the receive signal.

As a result, training sequences contained in preambles that precede data transmissions are employed to train AGCs to an appropriate level for each receive signal data path. This allows optimal MIMO data decoding to be performed at the MIMO receiver. AGC training and a resulting AGC level typically differ between SISO and MIMO communication systems since the power of the respective receive signals is different. Therefore, a receiver AGC may converge to an inappropriate level for MIMO data decoding if the preamble structure is inappropriate.

For example, a 2×2 MIMO communication system employing orthogonal frequency division multiplexing (OFDM) may transmit two independent and concurrent signals, employing two single-dimension transmitters having separate transmit antennas and two single-dimension receivers having separate receive antennas. Two receive signals Y₁(k), Y₂(k) on the k^{th} sub-carrier/tone following a Fast Fourier Transformation and assuming negligible inter-symbol interference may be written as:

Y₁(k)=H₁₁(k)*X₁(k)+H₁₂(k)*X₂(k)+N₁(k) (1)

Y₂(k)=H₂₁(k)*X₁(k)+H₂₂(k)*X₂(k)+N₂(k) (2)

where X₁(k) and X₂ (k) are two independent signals transmitted on the k^{th} sub-carrier/tone from the first and second transmit antennas, respectively, and N₁(k) and N₂(k) are noises associated with the two receive signals.

The channel coefficients Hᵢⱼ(k), where i=1, 2 and j=1, 2, incorporates gain and phase distortion associated with symbols transmitted on the k^{th} sub-carrier/tone from transmit antenna j to receive antenna i. The channel coefficients Hᵢⱼ(k) may also include gain and phase distortions due to signal conditioning stages such as filters and other analog electronics. The receiver is required to provide estimates of the channel coefficients Hᵢⱼ(k) to reliably decode the transmitted signals X₁ (k) and X₂ (k).

At the first receive antenna, the time domain channel representations from the first and second transmit antennas are given by h₁₁ [n] and h₁₂ [n] respectively. A receiver AGC could be trained by employing a single gain training sequence portion of a preamble resulting in a receive signal power of ∥h₁₁∥₂² at antenna one of the receiver. Here, ∥h₁₁∥₂² the square of the 2 norm of the time domain channel representation from transmit antenna 1 to receive antenna 1. Then the AGC level may be derived by employing the receiver analog-to-digital converter dynamic range (ADC_{DR}), the square root of the channel power ∥h₁₁∥₂ and a backoff level using the expression ADC_{DR}/(backoff level)/∥h₁₁∥₂. The backoff level is a measure of the peak-to-mean receive signal power values expected. For example, a backoff level of 12 dB (4:1 peak-to-mean) allows for two bits in the ADC conversion to accommodate peak values before clipping occurs. This AGC setting would ensure receiving a maximum signal strength for this backoff level in a SISO system. However, for MIMO operation, both transmit antennas typically emit independent data to give receive signal power of ∥h₁₁∥₂²+∥h₁₂∥₂² at antenna one, for example, which is different than that of the SISO system. This difference can cause clipping of some of the receive signals due to improperly set AGC levels and therefore generate transmission errors.

Accordingly, what is needed in the art is a more optimizing gain encoding structure or gain adjustment capability employable with MIMO communications systems.

### SUMMARY OF THE INVENTION

To address the above-discussed deficiencies of the prior art, the present invention provides a concurrent gain generator for use with a MIMO transmitter employing N transmit antennas, where N is at least two. In one embodiment, the concurrent gain generator includes a first sequence formatter configured to provide one of the N transmit antennas with a gain training sequence during an initial time interval. Additionally, the concurrent gain generator also includes a second sequence formatter coupled to the first sequence formatter and configured to further provide (N−1) remaining transmit antennas with (N−1) additional gain training sequences, respectively, during the initial time interval to train receive gains for multiple concurrent data transmissions.

In another aspect, the present invention provides a method of gain generating for use with a MIMO transmitter employing N transmit antennas, where N is at least two. The method includes providing one of the N transmit antennas with a gain training sequence during an initial time interval. The method also includes further providing (N−1) remaining transmit antennas with (N−1) additional gain training sequences, respectively, during the initial time interval to train receive gains for multiple concurrent data transmissions.

The present invention also provides, in yet another aspect, a MIMO communications system. The MIMO communications system employs a MIMO transmitter having N transmit antennas, where N is at least two, that provides multiple concurrent data transmissions and includes a concurrent gain generator that is coupled to the MIMO transmitter. The concurrent gain generator has a first sequence formatter that provides one of the N transmit antennas with a gain training sequence during an initial time interval. The concurrent gain generator also has a second sequence formatter, coupled to the first sequence formatter, that further provides (N−1) remaining transmit antennas with (N−1) additional gain training sequences, respectively, during the initial time interval to train receive gains for the multiple concurrent data transmissions. The MIMO communications system also employs a MIMO receiver, having M receive antennas, where M is at least two, that trains the receive gains and receives the multiple concurrent data transmissions.

Additionally, the present invention also provides a non-concurrent gain adjuster for use with a MIMO receiver employing M receive antennas, where M is at least two. In one embodiment, the non-concurrent gain adjuster includes a gain combiner configured to compute a common receive gain that is a function of M independent receive gains. The non-concurrent gain adjuster also includes a gain applier coupled to the gain combiner and configured to apply the common receive gain to receivers associated with the M receive antennas.

In another aspect, the present invention provides a method of gain adjusting for use with a MIMO receiver employing M receive antennas, where M is at least two. The method includes computing a common receive gain that is a function of M independent receive gains and applying the common receive gain to receivers associated with the M receive antennas.

The present invention also provides, in yet another aspect, a MIMO communications system employing a MIMO transmitter having N transmit antennas, where N is at least two, that provides multiple concurrent data transmissions, and a MIMO receiver having M receive antennas, where M is at least two, that establishes M independent receive gains. The MIMO communications system includes a non-concurrent gain adjuster, coupled to the MIMO receiver, having a gain combiner that computes a common receive gain that is a function of the M independent receive gains, and a gain applier that is coupled to the gain combiner and applies the common receive gain to the MIMO receiver to receive the multiple concurrent data transmissions.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of an NxM MIMO communication system constructed in accordance with the principles of the present invention;

FIG. 2 illustrates a diagram of an embodiment of a transmission frame format employable with a concurrent gain generator and constructed in accordance with the principles of the present invention;

FIG. 3 illustrates a diagram of an alternate embodiment of a transmission frame format employable with a concurrent gain generator and constructed in accordance with the principles of the present invention;

FIG. 4 illustrates a system diagram of an alternative embodiment of an N×M MIMO communication system constructed in accordance with the principles of the present invention;

FIG. 5 illustrates a diagram of an embodiment of a transmission frame format that produces individually established independent receive gains for data reception; and

FIG. 6 illustrates a flow diagram of an embodiment of a method of establishing receive gains carried out in accordance with the principles of the present invention.

### DETAILED DESCRIPTION

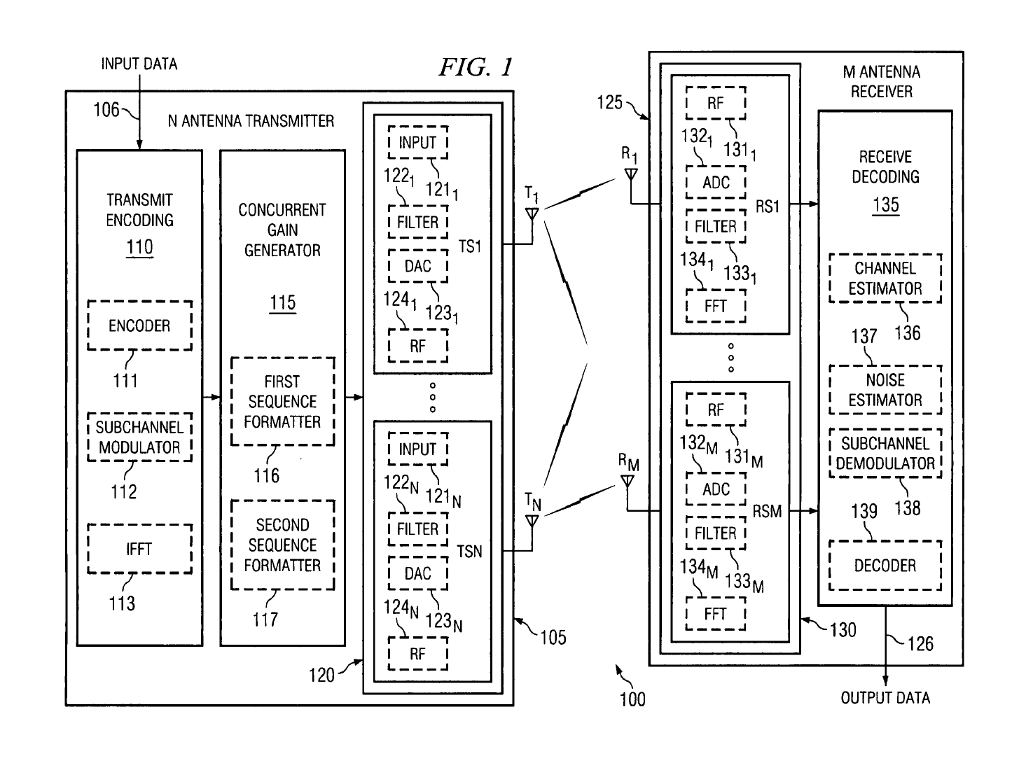

Referring initially to FIG. 1, illustrated is a system diagram of an embodiment of an N×M MIMO communication system, generally designated 100, constructed in accordance with the principles of the present invention. The MIMO communication system 100 includes a MIMO transmitter 105 and a MIMO receiver 125. The MIMO transmitter 105 includes input data 106, a transmit encoding system 110, a concurrent gain generator 115, and a transmit system 120 having N transmit sections TS1-TSN coupled to N transmit antennas T1-TN, respectively. The receiver 125 includes a receive system 130 having M receive sections RS1-RSM respectively coupled to M receive antennas R1-RM, and a receive decoding system 135 providing output data 126. In the embodiment of FIG. 1, N and M are at least two.

The transmit encoding system 110 includes an encoder 111, a subchannel modulator 112 and an Inverse Fast Fourier Transform (IFFT) section 113. The encoder 111, subchannel modulator 112 and IFFT section 113 prepare the input data and support the arrangement of preamble information and signal information for transmission by the transmit system 120. The concurrent gain generator 115 includes a first sequence formatter 116 and a second sequence formatter 117, which cooperate with the transmit encoding system 110 to generate a time-slot optimized preamble structure. This allows proper automatic gain control (AGC) training and communication channel estimation for the receiver 125, which is needed to process the transmission. Additionally, the first and second sequence formatters 116, 117 may be employed in either the frequency or time domain. For the time domain, an IFFT of the appropriate preamble information may be pre-computed and read from memory at the required transmission time.

The N transmit sections TS1-TSN include corresponding pluralities of N input sections 121₁-121_{N}, N filters 122₁-122_{N}, N digital-to-analog converters (DACs) 123₁-123_{N} and N radio frequency (RF) sections 124₁-124_{N}, respectively. The N transmit sections TS1-TSN provide a time domain signal proportional to preamble information, signal information and input data for transmission by the N transmit antennas T1-TN, respectively.

The M receive antennas R1-RM receive the transmission and provide it to the M respective receive sections RS1-RSM, which include corresponding M RF sections 131₁-131_{M}, M analog-to-digital converters (ADCs) 132₁-132_{M}, M filters 133₁-133_{M}, and M Fast Fourier Transform (FFT) sections 134₁-134_{M}, respectively. The M receive sections RS1-RSM employ a proper AGC level to provide a frequency domain digital signal to the receive decoding system 135. This digital signal is proportional the preamble information, signal information and input data. Setting of the proper AGC level is accomplished by establishing a proper ratio between a desired power level and a received power level for a selected ADC backoff level.

The receive decoding system 135 includes a channel estimator 136, a noise estimator 137, a subchannel demodulator 138 and a decoder 139 that employ the preamble information, signal information and input data to provide the output data 126. In the illustrated embodiment, the channel estimator 136 employs a portion of the preamble information for the purpose of estimating the communication channels.

In the concurrent gain generator 115, the first sequence formatter 116 provides one of the N transmit antennas with a gain training sequence during an initial time interval. The second sequence formatter 117 is coupled to the first sequence formatter 116 and further provides (N−1) remaining transmit antennas with (N−1) additional gain training sequences, respectively, during the initial time interval to train receive gains for the multiple concurrent data transmissions. The concurrent gain generator 115 provides a time-slot optimized preamble structure wherein an AGC level in the MIMO receiver 125 may be established without requiring additional time-slots thereby maintaining an overall communication efficiency.

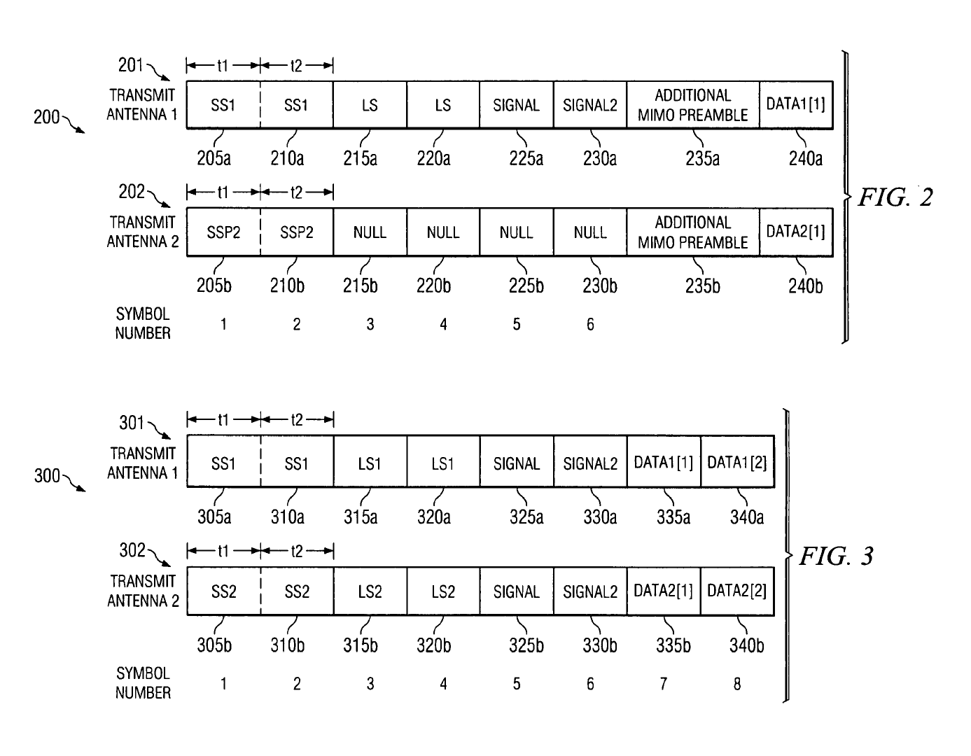

In one embodiment of the present invention, the gain training sequence is orthogonal to each member of the (N−1) additional gain training sequences for a time-slot optimized preamble structure. Additionally, channel estimation training sequences are time switched, which requires a gain adjustment at the MIMO receiver 125. In an alternative embodiment, the gain training sequence and the (N−1) additional gain training sequences are orthogonal in a time-slot optimized preamble structure, but the channel estimation training sequences are time-slot optimized, which does not require gain adjustment at the MIMO receiver 125. These two embodiments will be further discussed with respect to FIGS. 2 and 3. In each of these embodiments, the first gain training sequence may conform to a standard selected from the group consisting of IEEE 802.11a and IEEE 802.11g, as appropriate to a particular application.

The scalable property of the concurrent gain generator 115 allows it to accommodate a MIMO transmitter that employs an N of two or more transmit antennas. This property accommodates an associated MIMO receiver, having an M of two or more receive antennas, to effectively provide receive AGC levels associated with each of the M receive antennas. These AGC levels are appropriate to accommodate additional MIMO preambles and MIMO data portions of a reception.

Those skilled in the pertinent art will understand that the present invention can be applied to conventional or future-discovered MIMO communication systems. For example, these systems may form a part of a narrowband wireless communication system employing multiple antennas, a broadband communication system employing time division multiple access (TDMA) or a general multiuser communication system.

Turning now to FIG. 2, illustrated is a diagram of an embodiment of a transmission frame format, generally designated 200, employable with a concurrent gain generator and constructed in accordance with the principles of the present invention. The transmission frame format 200 may be employed with a MIMO transmitter having first and second transmit antennas and a MIMO receiver having first and second receive antennas, as was generally discussed with respect to FIG. 1, where N and M are equal to two. The transmission frame format 200 includes first and second transmission frames 201, 202 that are organized in a time-slot optimized preamble structure and associated with the first and second transmit antennas, respectively.

The first and second transmission frames 201, 202 include first and second gain training sequences 205a, 210a and corresponding first and second additional gain training sequences 205b, 210b, during first and second initial time intervals t1, t2, respectively. The first and second transmission frames 201, 202 also include first and second channel estimation training sequences 215a, 220a, first and second signal fields 225a, 230a, and corresponding first, second, third and fourth nulls 215b, 220b, 225b, 230b, respectively. Additionally, the first and second transmission frames 201, 202 further include first additional MIMO preamble and data fields 235a, 240a and corresponding second additional MIMO preamble and MIMO data fields 235b, 240b, respectively.

In the illustrated and alternative embodiments, the nulls employed may be zero functions that, by definition, are zero almost everywhere, or null sequences of numerical values that converge to zero. Alternatively, the nulls may be an un-modulated transmission, a transmission employing substantially zero modulation or a period of no transmission. Of course, each of the nulls may be differing or the same employing current or future-developed formats, as advantageously required by a particular application.

In the illustrated embodiment, the first and second gain training sequences 205a, 210a are orthogonal to the corresponding first and second additional gain training sequences 205b, 210b. This gain-training portion of the transmission frame format 200 provides a receive power that is equal to ∥h₁₁∥₂²+∥h₁₂∥₂² for a first receive section and equal to ∥h₂₁∥₂²+∥h₂₂∥₂² for a second receive section during AGC training. These are the same receive powers that occur for both the additional MIMO preambles 235a, 235b and the MIMO data fields 235b, 240b.

Therefore, an appropriate AGC level occurs during AGC training for proper reception of the additional MIMO preambles 235a, 235b and data fields 235b, 240b thereby satisfying the power requirements without wasting extra preamble time slots in AGC retraining for MIMO systems. Additionally, this embodiment achieves the proper AGC level without having to sacrifice the structure of a legacy preamble based on IEEE 802.11a/g.

In the illustrated embodiment, the first and second channel estimation training sequences 215a, 220a and corresponding first and second nulls 215b, 220b constitute a time-switched format. Whereas alternative embodiments may appropriately include other formats, this time-switched format may be used to simplify the channel estimation process, since only transmit antenna one is sending nonzero information. This format may substantially optimize the signal-to-noise ratio of the channel estimation process, which is generally true for the signal field portions of the transmission frame, as well. However, the time-slot optimized preamble structure afforded by the transmission frame format 200 requires a gain adjustment for the channel estimation and signal fields for proper operation at the MIMO receiver.

Turning now to FIG. 3, illustrated is a diagram of an alternative embodiment of a transmission frame format, generally designated 300, employable with a concurrent gain generator and constructed in accordance with the principles of the present invention. The transmission frame format 300 may also be employed with a MIMO transmitter having first and second transmit antennas and a MIMO receiver having first and second receive antennas, as was generally discussed with respect to FIG. 1, where N and M are equal to two. The transmission frame format 300 includes first and second transmission frames 301, 302 that are organized in a time-slot optimized preamble structure and associated with the first and second transmit antennas, respectively.

The first and second transmission frames 301, 302, which are also time-slot optimized, include first and second gain training sequences 305a, 310a and corresponding first and second additional gain training sequences 305b, 310b, during first and second initial time intervals t1, t2, respectively. The first and second transmission frames 301, 302 also include first and second channel estimation training sequences 315a, 320a, first and second signal fields 325a, 330a, and corresponding third and fourth channel estimation training sequences 315b, 320b and repeated first and second signal fields 325b, 330b, respectively. Additionally, the first and second transmission frames 301, 302 further include first and second MIMO data fields 335a, 340a and corresponding third and fourth MIMO data fields 335b, 340b, respectively.

In the illustrated embodiment, the first and second gain training sequences 305a, 310a and the corresponding first and second additional gain training sequences 305b, 310b can train the AGC levels for first and second receive sections to a value that is appropriate for data decode without employing additional gain adjustments. The gain for each receive path i converges to:

$${G}_{i} = \frac{K}{\sqrt{{‖ {h}_{i 1} ‖}_{2}^{2} + {‖ {h}_{i 2} ‖}_{2}^{2}}} ,$$

where i=1, 2 for the first and second receive sections, respectively and ∥hᵢⱼ∥₂² iS the square of the 2 norm of the time domain channel representation hᵢⱼ from transmit antenna j to receive antenna i. For this embodiment, the first and second channel estimation training sequences 315a, 320a and the corresponding third and fourth channel estimation training sequences 315b, 320b do not require a gain adjustment at a receiver.

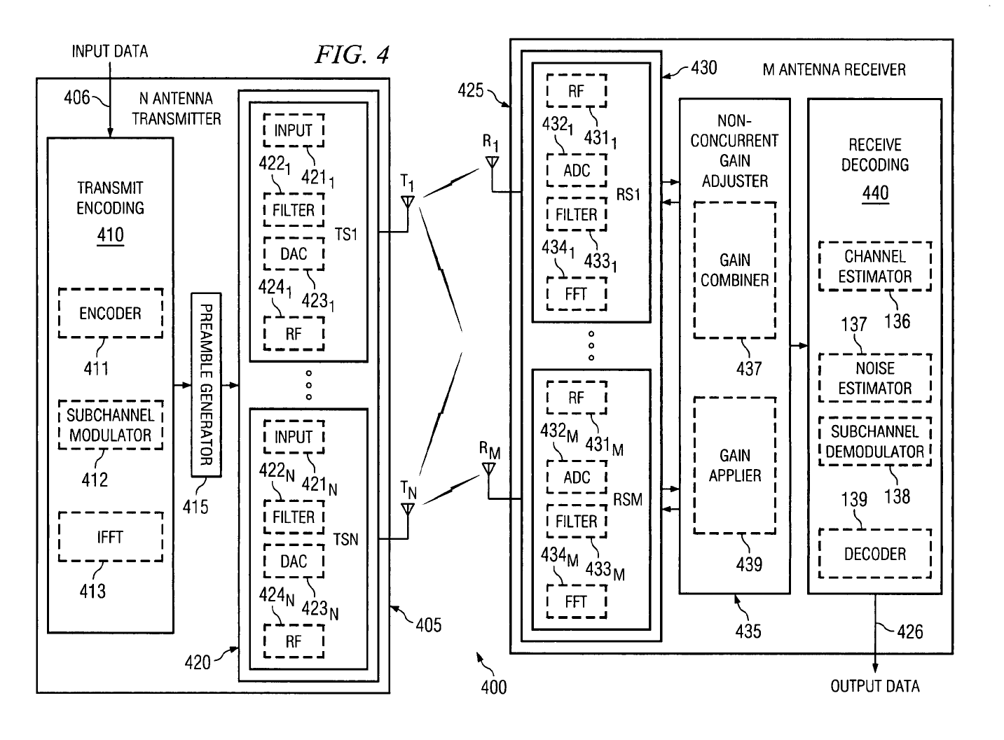

Turning now to FIG. 4, illustrated is a system diagram of an alternative embodiment of an N×M MIMO communication system, generally designated 400, constructed in accordance with the principles of the present invention. The MIMO communication system 400 includes a MIMO transmitter 405 that provides multiple concurrent data transmissions and a MIMO receiver 425 that may initially establish independent gains. The MIMO transmitter 405 includes input data 406, a transmit encoding system 410, a preamble generator 415, and a transmit system 420 having N transmit sections TS1-TSN coupled to N transmit antennas T1-TN, respectively. The MIMO receiver 425 includes a receive system 430 having M receive sections RS1-RSM respectively coupled to M receive antennas R1-RM, a non-concurrent gain adjuster 435 and a receive decoding system 440 providing output data 426. In the embodiment of FIG. 4, N and M are at least two.

The transmit encoding system 410 includes an encoder 411, a subchannel modulator 412 and an Inverse Fast Fourier Transform (IFFT) section 413. Operation of these units parallel the operation their corresponding units as was discussed with respect to FIG. 1. The preamble generator 415 cooperates with the transmit encoding system 410, to generate a preamble structure that is generally not time-slot optimized and typically produces sequences that result in independent automatic gain control (AGC) training for each data path in the MIMO receiver 425. The N transmit sections TS1-TSN include corresponding pluralities of N input sections 4211-421N, N filters 422₁-422_{N}, N digital-to-analog converters (DACs) 4231-423N and N radio frequency (RF) sections 424₁-424_{N}, respectively. Operation of these units also parallels the operation their corresponding units as was discussed with respect to FIG. 1.

The M receive antennas R1-RM receive the transmission and provide it to the M respective receive sections RS1-RSM, which include corresponding M RF sections 431₁-431_{M}, M analog-to-digital converters (ADCs) 432₁-432_{M}, M filters 433₁-433_{M} and M Fast Fourier Transform (FFT) sections 434₁-434_{M}, respectively. Generally, operation of these units parallels the operation of their corresponding units as was discussed with respect to FIG. 1. However, the AGC levels associated with the respective receive sections RS1-RSM were achieved using time-switched gain training sequences, and therefore the gain levels are not correct for MIMO data symbol decoding. Setting of proper AGC levels is accomplished by the non-concurrent gain adjuster 435 to provide a frequency domain digital signal to the receive decoding system 440, whose general operation parallels the operation its corresponding unit as was discussed with respect to FIG. 1.

The non-concurrent gain adjuster 440 includes a gain combiner 437 and a gain applier 439, which is coupled to the gain combiner 437. The gain combiner 437 computes a common receive gain that is a function of M independent receive gains for each of the M receive sections RS1-RSM. Correspondingly, the gain applier 439 applies the appropriate common receive gain to the corresponding M receive sections RS1-RSM thereby allowing appropriate decoding of the multiple concurrent data transmissions. The common receive gain is the product of the M independent receive gains divided by the square root of the sum of the squares of the M independent receive gains. These common receive gains are appropriate to accommodate additional MIMO preambles and MIMO data portions of a reception.

The non-concurrent gain adjuster 435 employs a scalable property that allows it to accommodate a MIMO transmitter employing an N of two or more transmit antennas. Correspondingly, an associated MIMO receiver, having an M of two or more receive antennas, may also be accommodated to effectively provide an appropriate receive AGC level for MIMO data reception that is associated with each of the M receive antennas.

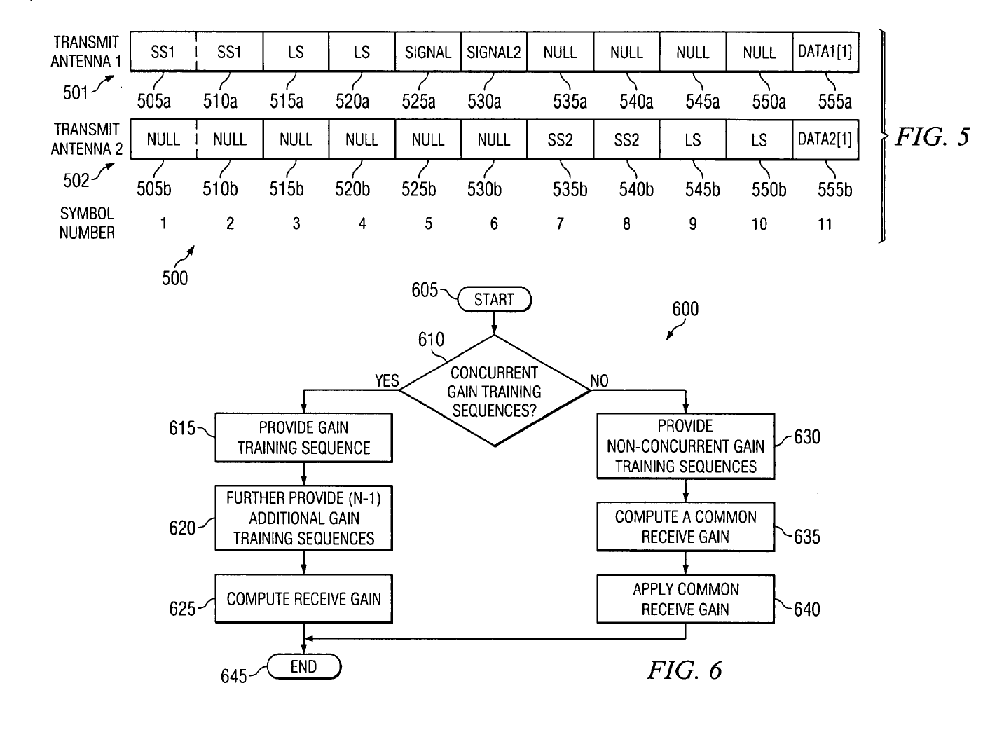

Turning momentarily to FIG. 5, illustrated is a diagram of an embodiment of a transmission frame format, generally designated 500, that employs time-switched training sequences to produce individual gain training that establishes independent receive gains for data reception at a receiver. The transmission frame format 500 is employable with a preamble generator associated with a MIMO transmitter having first and second transmit antennas and a non-concurrent gain adjuster associated with a MIMO receiver having first and second receive antennas, as was generally discussed with respect to FIG. 4 where N and M are equal to two. The transmission frame format 500 includes first and second transmission frames 501, 502 that are respectively associated with first and second transmit antennas of the MIMO transmitter.

The first and second transmission frames 501, 502 include first and second gain training sequences 505a, 510a, first and second channel estimation training sequences 515a, 520a, and first and second signal fields 525a, 530a, as well as corresponding first, second, third, fourth, fifth and sixth nulls 505b, 510b, 515b, 520b, 525b, 530b, respectively. The first and second transmission frames 501, 502 also include seventh, eighth, ninth and tenth nulls 535a, 540a, 545a, 550a and a first MIMO data field 555a, as well as corresponding third and fourth gain training sequences 535b, 540b, third and fourth channel estimate training sequences 545b, 550b and a corresponding second MIMO data field 555b, respectively.

The first and second transmission frames 501, 502 are exemplary of a preamble form that may be employed to easily optimize the signal-to-noise ratio (SNR) of the channel estimation process. However, since the first and second gain training sequences 505a, 510a and the third and fourth gain training sequences 535b, 540b occur independently (i.e., only one non-zero transmission at a time) they produce independent receive gains during the AGC process that are inappropriate for MIMO data reception.

Returning now to FIG. 4, the non-concurrent gain adjuster 435 ensures that the receive AGC is set to a value that is representative of the MIMO data power for preamble structures such as the exemplary transmission frame format 500. For the transmission frame format 500 where N and M are equal to two, first and second receive signals Y₁[k], Y₂[k] may be expressed as:

Y₁(k)=H₁₁(k)*X₁(k)+H₁₂(k)*X₂(k) (3)

Y₂(k)=H₂₁(k)*X₁(k)+H₂₂(k)*X₂(k) (4)

where Hᵢⱼ represents the frequency domain channel response from the transmit antenna j to the receive antenna i wherein the noise terms are assumed to be negligible. For the notations defined previously and a given receive data path i, the AGC converges to a first independent receive gain having a value of:

$${G}_{i 1} = \frac{K}{{‖ {h}_{i 1} ‖}_{2}} \qquad ( 5 )$$

during the first and second gain training sequences 505a, 510a. Then, during the third and fourth gain training sequences 535b, 540b the AGC converges to a second independent receive gain having a value of:

$${G}_{i 2} = \frac{K}{{‖ {h}_{i 2} ‖}_{2}} . \qquad ( 6 )$$

In each of these cases

$$K = \sqrt{\frac{Desired Power}{Actual Power}} . \qquad ( 7 )$$

The non-concurrent gain adjuster 435 employs these two independent gains to re-adjust the AGC gain to a common receive gain (CRG) for proper MIMO data decode for each receive data path i to a level of:

$$CRG = \frac{{G}_{i 1} {G}_{i 2}}{\sqrt{{G}_{i 1}^{2} + {G}_{i 2}^{2}}} . \qquad ( 8 )$$

Generally, the values of the first and second independent receive gains Gᵢ₁, Gᵢ₂ are different from each other because the individual channel powers are different. The relative gain between the first and second independent receive gains Gᵢ₁, Gᵢ₂ and the CRG is properly accounted for in the data decode for proper reception of the MIMO data by the non-concurrent gain adjuster 435.

Turning now to FIG. 6, illustrated is a flow diagram of an embodiment of a method of establishing receive gains, generally designated 600, carried out in accordance with the principles of the present invention. The method 600 may be employed with a MIMO transmitter having N transmit antennas and a MIMO receiver having M receive antennas, where N and M are at least two, and starts in a step 605. In a decisional step 610, a determination is made as to whether gain training sequences employed will provide a receiver AGC level that is appropriate for MIMO data reception without further adjustment.

If the gain training sequences are time-slot optimized and concurrent, they are appropriate for MIMO data reception. A gain training sequence is provided to one of the N transmit antennas during an initial time interval in a step 615. Then in a step 620, (N−1) additional gain training sequences are further provided, respectively, to the (N−1) remaining transmit antennas during the initial time interval to train receive gains for multiple concurrent data transmissions. In one embodiment of the method 600, the gain training sequence conforms to a standard selected from the group consisting of IEEE 802.11a and IEEE 802.11g.

In an alternative embodiment, the gain training sequence is orthogonal to the (N−1) additional gain training sequences wherein subsequent channel estimate training sequences follow the gain training sequence and nulls follow (N−1) additional gain training sequences in a time-switched format. In yet another embodiment, the gain training sequence and (N−1) additional gain training sequences are again orthogonal and channel estimate training sequences are time-slot optimized to follow both the gain training sequence and each of the (N−1) additional gain training sequences. Each of these embodiments allows a receive gain calculation to provide a receive AGC level that is appropriate for additional MIMO preamble or MIMO data reception, in a step 625. However, the subsequent channel estimates may require gain adjustment at a receiver for proper data decoding. Then, the method 600 ends in a step 645.

If the gain training sequences are not concurrent and therefore not optimized for MIMO data reception, N gain training sequences are provided to the N transmit antennas in a step 630. The N gain training sequences may employ a time-switched training sequence format or another appropriate format that provides independent receive gains. A common receive gain is computed in a step 635 that is a function of all of the independent receive gains. The common receive gain is proportional to the product of the independent receive gains divided by the square root of the sum of the squares of the independent receive gains. Then in a step 640, the common receive gain is applied to receivers associated with receive antennas. Again, the method 600 ends in the step 645.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a concurrent gain generator, a method of gain generating and a MIMO communications system employing the generator or method have been presented. Advantages of these embodiments include substantially enhancing the signal-to-noise ratio for additional MIMO preambles and MIMO data portions of a reception without sacrificing legacy preamble structures appropriate for IEEE 802.11a/g systems. These embodiments also employ preamble structures that are time-slot optimized and efficient in that they do not require extra time slots for retraining receive AGC.

Additionally, an embodiment employing a non-concurrent gain adjuster, a method for gain adjusting and a MIMO communications system employing the adjuster or method have also been presented. Advantages of this embodiment include the ability to provide a proper receive AGC level for additional MIMO preambles and MIMO data portion receptions. This proper receive AGC level is based on a common receive gain that is a function of independent receive gains.

Of course, one skilled in the pertinent art will realize that the embodiments presented herein are exemplary, and that the present invention includes other preamble embodiments, not specifically illustrated, that embody the preamble design methodologies associated with the embodiments presented. This includes employing N×M MIMO communications systems having more than two transmit antennas and more than two receive antennas, as well.

Although the present invention has been described in detail, those skilled in the art should understand that they can make various changes, substitutions and alterations herein without departing from the spirit and scope of the invention in its broadest form.

1-12. (canceled)

13. A non-concurrent gain adjuster for use with a multiple-input, multiple output (MIMO) receiver employing M receive antennas, where M is at least two, comprising:
a gain combiner configured to compute a common receive gain that is a function of M independent receive gains; and
a gain applier coupled to said gain combiner and configured to apply said common receive gain to receivers associated with said M receive antennas.

14. The adjuster as recited in claim 13 wherein said common receive gain is the product of said M independent receive gains divided by the square root of the sum of the squares of said M independent receive gains.

15. A method of gain adjusting for use with a multiple-input, multiple output (MIMO) receiver employing M receive antennas, where M is at least two, comprising:
computing a common receive gain that is a function of M independent receive gains; and
applying said common receive gain to receivers associated with said M receive antennas.

16. The method as recited in claim 15 wherein said common receive gain is the product of said M independent receive gains divided by the square root of the sum of the squares of said M independent receive gains.

17. A multiple-input, multiple output (MIMO) communications system, comprising:
a MIMO transmitter employing N transmit antennas, where N is at least two, that provides multiple concurrent data transmissions;
a MIMO receiver employing M receive antennas, where M is at least two, that establishes M independent receive gains; and
a non-concurrent gain adjuster that is coupled to said MIMO receiver, including:
a gain combiner that computes a common receive gain that is a function of said M independent receive gains; and
a gain applier, coupled to said gain combiner, that applies said common receive gain to said MIMO receiver to receive said multiple concurrent data transmissions.

18. The communication system as recited in claim 17 wherein said common receive gain is the product of said M independent receive gains divided by the square root of the sum of the squares of said M independent receive gains.
